(19) United States
(12) Patent Application Publication
(10) Pub. No.: US 2005/0220128 A1
(43) Pub. Date: Oct. 6, 2005

(54) System and method for work request queuing for intelligent adapter

(75) Inventors: Tom Tucker, Austin, TX (US); Larry Steven Wise, Austin, TX (US)

Correspondence Address: WILMER CUTLER PICKERING HALE AND DORR LLP, 60 STATE STREET, BOSTON, MA, 02109, US

(73) Assignee: Ammasso, Inc.

(21) Appl. No.: 10/915,940

(22) Filed: Aug. 11, 2004

Related U.S. Application Data
(60) Provisional application No. 60/559,557, filed on Apr. 5, 2004.

(51) Int. Cl. H04L 12/56

(52) U.S. Cl. 370/412; 370/463

(57) ABSTRACT

A system and method for work request queuing for an intelligent network interface card or adapter. More specifically, the invention provides a method and system that efficiently supports an extremely large number of work request queues. A virtual queue interface is presented to the host, and supported on the “back end” by a real queue shared among many multiple virtual queues. A message queue subsystem for an RDMA capable network interface includes a memory mapped virtual queue interface. The queue interface has a large plurality of virtual message queues with each virtual queue mapped to a specified range of memory address space. The subsystem includes logic to detect work requests on a host interface bus to at least one of specified address ranges corresponding to one of the virtual queues and logic to place the work requests into a real queue that is memory based and shared among at least some of the plurality of virtual queues, and wherein real queue entries include indications of the virtual queue to which the work request was addressed.

### CROSS-REFERENCE TO RELATED APPLICATION

This application claims priority under 35 U.S.C. § 19(e) to U.S. Provisional Patent Application No. 60/559,557, filed on Apr. 5, 2004, entitled SYSTEM AND METHOD FOR REMOTE DIRECT MEMORY ACCESS, which is expressly incorporated herein by reference in its entirety.

This application is related to U.S. Patent Application Nos. <to be determined>, filed on even date herewith entitled SYSTEM AND METHOD FOR PLACEMENT OF RDMA PAYLOAD INTO APPLICATION MEMORY OF A PROCESSOR SYSTEM and SYSTEM AND METHOD FOR PLACEMENT OF SHARING PHYSICAL BUFFER LISTS IN RDMA COMMUNICATION, which are incorporated herein by reference in their entirety.

### BACKGROUND

1. Field of the Invention

This invention relates to network interfaces and more particularly to RDMA capable Network Interfaces that intelligently handle work request queuing.

2. Discussion of Related Art

Implementation of multi-tiered architectures, distributed Internet-based applications, and the growing use of clustering and grid computing is driving an explosive demand for more network and system performance, putting considerable pressure on enterprise data centers.

With continuing advancements in network technology, particularly 1 Gbit and 10 Gbit Ethernet, connection speeds are growing faster than the memory bandwidth of the servers that handle the network traffic. Combined with the added problem of ever-increasing amounts of data that need to be transmitted, data centers are now facing an “I/O bottleneck”. This bottleneck has resulted in reduced scalability of applications and systems, as well as, lower overall systems performance.

There are a number of approaches on the market today that try to address these issues. Two of these are leveraging TCP/IP offload on Ethernet networks and deploying specialized networks. A TCP/IP Offload Engine (TOE) offloads the processing of the TCP/IP stack to a network coprocessor, thus reducing the load on the CPU. However, a TOE does not completely reduce data copying, nor does it reduce user-kernel context switching—it merely moves these to the coprocessor. TOEs also queue messages to reduce interrupts, and this can add to latency.

Another approach is to implement specialized solutions, such as InfiniBand, which typically offer high performance and low latency, but at relatively high cost and complexity. A major disadvantage of InfiniBand and other such solutions is that they require customers to add another interconnect network to an infrastructure that already includes Ethernet and, oftentimes, Fibre Channel for storage area networks. Additionally, since the cluster fabric is not backwards compatible with Ethernet, an entire new network build-out is required.

One approach to increasing memory and I/O bandwidth while reducing latency is the development of Remote Direct Memory Access (RDMA), a set of protocols that enable the movement of data from the memory of one computer directly into the memory of another computer without involving the operating system of either system. By bypassing the kernel, RDMA eliminates copying operations and reduces host CPU usage. This provides a significant component of the solution to the ongoing latency and memory bandwidth problem.

Once a connection has been established, RDMA enables the movement of data from the memory of one computer directly into the memory of another computer without involving the operating system of either node. RDMA supports “zerocopy” networking by enabling the network adapter to transfer data directly to or from application memory, eliminating the need to copy data between application memory and the data buffers in the operating system. When an application performs an RDMA Read or Write request, the application data is delivered directly to the network, hence latency is reduced and applications can transfer messages faster (see FIG. 1).

RDMA reduces demand on the host CPU by enabling applications to directly issue commands to the adapter without having to execute a kernel call (referred to as “kernel bypass”). The RDMA request is issued from an application running on one server to the local adapter and then carried over the network to the remote adapter without requiring operating system involvement at either end. Since all of the information pertaining to the remote virtual memory address is contained in the RDMA message itself, and host and remote memory protection issues were checked during connection establishment, the remote operating system does not need to be involved in each message. The RDMA-enabled network adapter implements all of the required RDMA operations, as well as, the processing of the TCP/IP protocol stack, thus reducing demand on the CPU and providing a significant advantage over standard adapters (see FIG. 2).

Several different APIs and mechanisms have been proposed to utilize RDMA, including the Direct Access Provider Layer (DAPL), the Message Passing Interface (MPI), the Sockets Direct Protocol (SDP), iSCSI extensions for RDMA (iSER), and the Direct Access File System (DAFS). In addition, the RDMA Consortium proposes relevant specifications including the SDP and iSER protocols and the Verbs specification (more below). The Direct Access Transport (DAT) Collaborative is also defining APIs to exploit RDMA. (These APIs and specifications are extensive and readers are referred to the relevant organizational bodies for full specifications. This description discusses only select, relevant features to the extent necessary to understand the invention.)

FIG. 3 illustrates the stacked nature of an exemplary RDMA capable Network Interface Card (RNIC). The semantics of the interface is defined by the Verbs layer. Though the figure shows the RNIC card as implementing many of the layers including part of the Verbs layer, this is exemplary only. The standard does not specify implementation, and in fact everything may be implemented in software yet comply with the standards.

In the exemplary arrangement, the DDP layer is responsible for direct data placement. Typically, this layer places data into a tagged buffer or untagged buffer, depending on the model chosen. In the tagged buffer model, the location to place the data is identified via a steering tag (STag) and a target offset (TO), each of which is described in the relevant specifications, and only discussed here to the extent necessary to understand the invention.

Other layers such as RDMAP extend the functionality and provide for things like RDMA read operations and several types of writing tagged and untagged data.

The behavior of the RNIC (i.e., the manner in which uppers layers can interact with the RNIC) is a consequence of the Verbs specification. The Verbs layer describes things like (1) how to establish a connection, (2) the send queue/receive queue (Queue Pair or QP), (3) completion queues, (4) memory registration and access rights, and (5) work request processing and ordering rules.

A QP includes a Send Queue and a Receive Queue, each sometimes called a work queue. A Verbs consumer (e.g., upper layer software) establishes communication with a remote process by connecting the QP to a QP owned by the remote process. A given process may have many QPs, one for each remote process with which it communicates.

Sends, RDMA Reads, and RDMA Writes are posted to a Send Queue. Receives are posted to a Receive Queue (i.e., receive buffers with data that are the target for incoming Send messages). Another queue called a Completion Queue is used to signal a Verbs consumer when a Send Queue WQE completes, when such notification function is chosen. A Completion Queue may be associated with one or more work queues. Completion may be detected, for example, by polling a Completion Queue for new entries or via a Completion Queue event handler.

The Verbs consumer interacts with these queues by posting a Work Queue Element (WQE) to the queues. Each WQE is a descriptor for an operation. Among other things, it contains (1) a work request identifier, (2) operation type, (3) scatter or gather lists as appropriate for the operation, (4) information indicating whether completion should be signaled or unsignalled, and (5) the relevant STags for the operation, e.g., RDMA Write.

Logically, a STag is a network-wide memory pointer. STags are used in two ways: by remote peers in a Tagged DDP message to write data to a particular memory location in the local host, and by the host to identify a contiguous region of virtual memory into which Untagged DDP data may be placed.

There are two types of memory access under the RDMA model of memory management: memory regions and memory windows. Memory Regions are memory buffers registered by applications for remote access. A region is mapped to a set of (not necessarily contiguous) physical pages. Specified Verbs (e.g., Register Shared Memory Region) are used to manage regions. Memory windows may be created within established memory regions to subdivide that region to give different nodes specific access permissions to different areas.

The Verbs specification is agnostic to the underlying implementation of the queuing model.

### SUMMARY

The invention provides a system and method for work request queuing for an intelligent network interface card or adapter. More specifically, the invention provides a method and system that efficiently supports an extremely large number of work request queues. A virtual queue interface is presented to the host, and supported on the “back end” by a real queue shared among many multiple virtual queues.

According to one aspect of the invention, a message queue subsystem for an RDMA capable network interface includes a memory mapped virtual queue interface. The queue interface has a large plurality of virtual message queues with each virtual queue mapped to a specified range of memory address space. The subsystem includes logic to detect work requests on a host interface bus to at least one of specified address ranges corresponding to one of the virtual queues and logic to place the work requests into a real queue that is memory based and shared among at least some of the plurality of virtual queues, and wherein real queue entries include indications of the virtual queue to which the work request was addressed.

According to another aspect of the invention, the virtual queues include send queues and receive queues and data for a queue entry is resident in memory on the network interface.

According to another aspect of the invention, the message queue subsystem includes a completion queue interface, in which each virtual queue has a corresponding completion queue, and in which each completion queue has its queue entries resident in host memory thereby avoiding host read requests to the network interface memory to determine completion status.

According to another aspect of the invention, the real queue is a linked list of queue entries and wherein the queue subsystem includes hardware logic to manage the linked list.

According to another aspect of the invention, each virtual queue is organized on page boundaries of memory address space.

According to another aspect of the invention, the virtual queues are organized as a memory array based off an address programmed into a base address register of the network interface.

### BRIEF DESCRIPTION OF THE DRAWING

In the Drawing,

FIG. 1 illustrates a host-to-host communication each employing RDMA NICs;

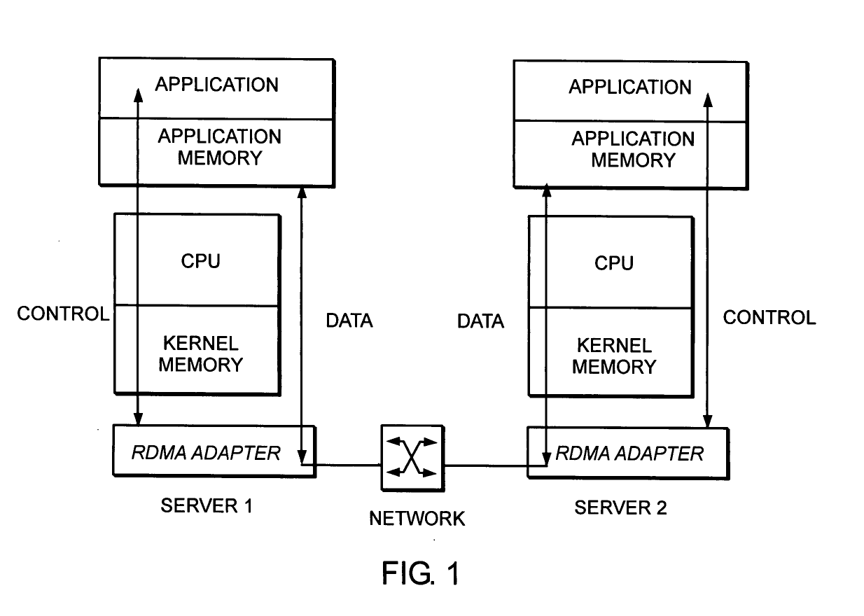

FIG. 2 illustrates a RDMA NIC;

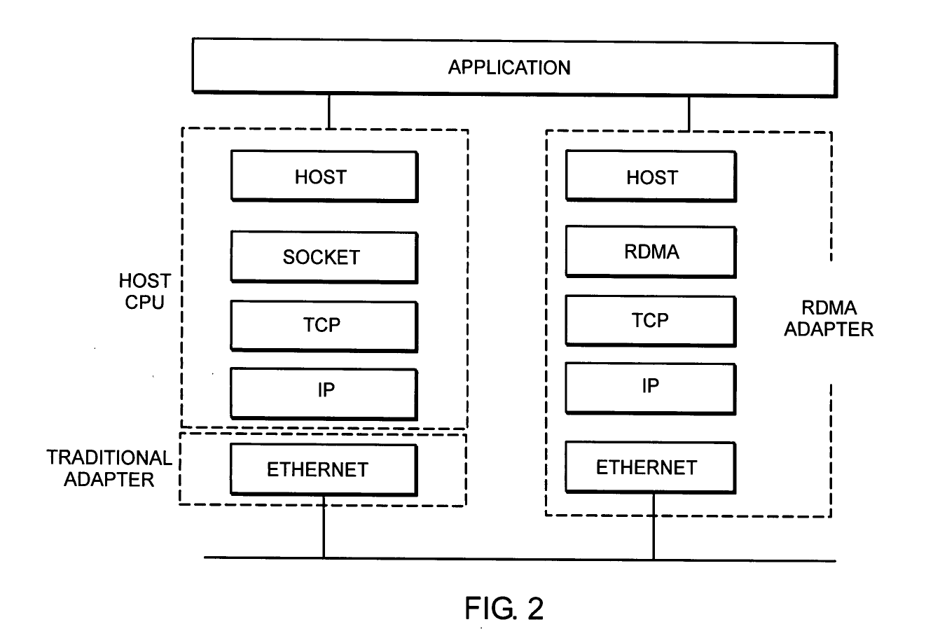

FIG. 3 illustrates a stacked architecture for RDMA communication;

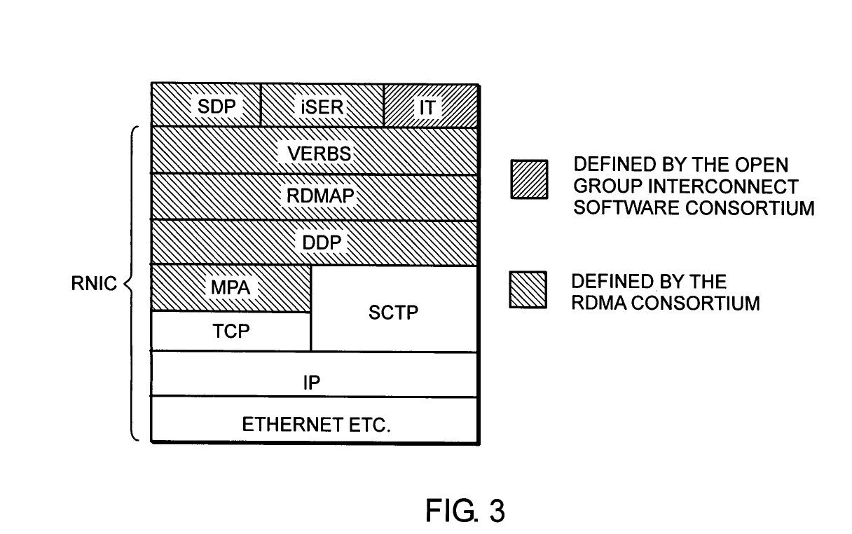

FIG. 4 is a high-level depiction of the architecture of certain embodiments of the invention;

FIG. 5 illustrates the RNIC architecture of certain embodiments of the invention;

FIG. 6 illustrates the message queue subsystem of certain embodiments of the invention;

FIG. 7 is a state diagram of the work request buffers of certain embodiments of the invention;

FIG. 8 is a block diagram of the PCI logic of certain embodiments of the invention; and

FIG. 9 illustrates the memory organization of the memory queue subsystem of certain embodiments of the invention.

### DETAILED DESCRIPTION

Preferred embodiments of the invention provide a method and system that efficiently supports an extremely large number of work request queues. More specifically, a virtual queue interface is presented to the host, and supported on the “back end” by a real queue shared among many multiple virtual queues. In this fashion, the work request queues comply with RDMA and other relevant specifications, yet require a relatively small amount of memory resources. Consequently, an RNIC implementing the invention may support efficiently support a large number of RDMA connections and sessions for a given amount of memory resources on the RNIC.

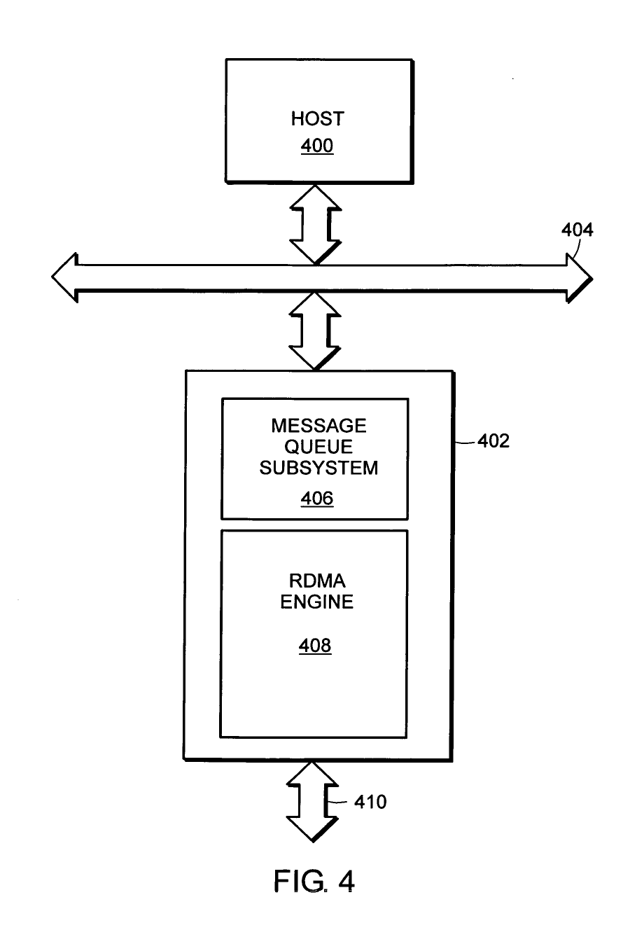

FIG. 4 is a high-level depiction of an RNIC according to a preferred embodiment of the invention. A host computer 400 communicates with the RNIC 402 via a predefined interface 404 (e.g., PCI bus interface). The RNIC 402 includes an message queue subsystem 406 and a RDMA engine 408. The message queue subsystem 406 is primarily responsible for providing the specified work queues and communicating via the specified host interface 404. The RDMA engine interacts with the message queue subsystem 406 and is also responsible for handling communications on the back-end communication link 410, e.g., a Gigabit Ethernet link.

For purposes of understanding this invention, further detail about the RDMA engine 402 is not needed. However, this engine is described in co-pending U.S. Patent Application Nos. <to be determined>, filed on even date herewith entitled SYSTEM AND METHOD FOR PLACEMENT OF RDMA PAYLOAD INTO APPLICATION MEMORY OF A PROCESSOR SYSTEM and SYSTEM AND METHOD FOR PLACEMENT OF SHARING PHYSICAL BUFFER LISTS IN RDMA COMMUNICATION, which are incorporated herein by reference in their entirety.

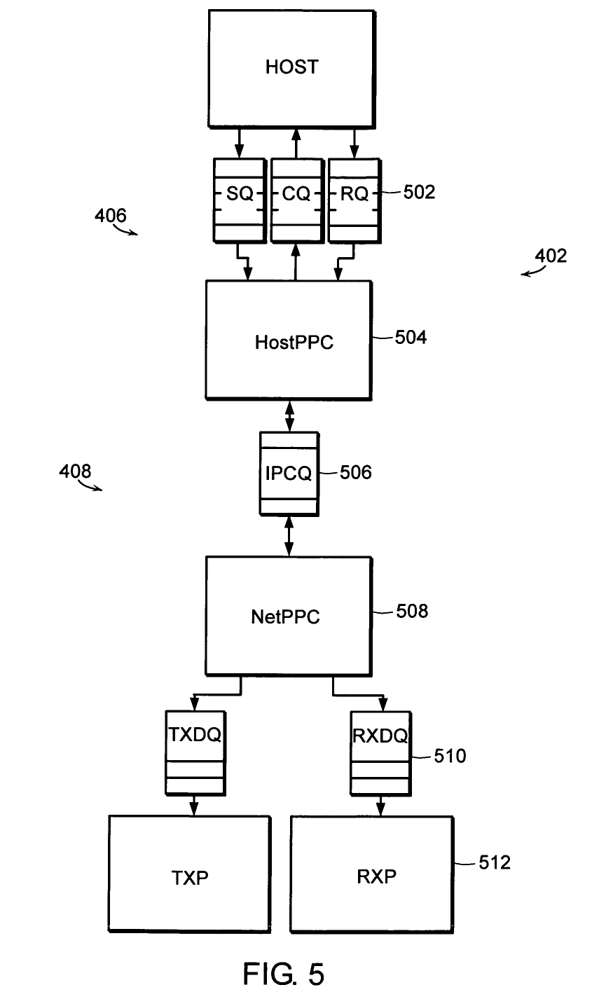

FIG. 5 depicts a preferred RNIC implementation. The RNIC 402 contains two on-chip processors 504, 508. Each processor has 16 k of program cache and 16 k of data cache. The processors also contain a separate instruction side and data side on chip memory busses. Sixteen kilobytes of BRAM is assigned to each processor to contain firmware code that is run frequently.

The processors are partitioned as a host processor 504 and network processor 508. The host processor 504 is used to handle host interface functions and the network processor 508 is used to handle network processing. Processor partitioning is also reflected in the attachment of on-chip peripherals to processors. The host processor 504 has interfaces to the host 400 through memory-mapped message queues 502 and PCI interrupt facilities while the network processor 508 is connected to the network processing hardware 512 through on-chip memory descriptor queues 510.

The host processor 504 acts as command and control agent. It accepts work requests from the host and turns these commands into data transfer requests to the network processor 508.

For data transfer, there are three work request queues, the Send Queue (SQ), Receive Queue (RQ), and Completion Queue (CQ). The SQ and RQ contain work queue elements (WQE) that represent send and receive data transfer operations (DTO). The CQ contains completion queue entries (CQE) that represent the completion of a WQE. The submission of a WQE to an SQ or RQ and the receipt of a completion indication in the CQ (CQE) are asynchronous.

The host processor 504 is responsible for the interface to host. The interface to the host consists of a number of hardware and software queues. These queues are used by the host to submit work requests (WR) to the adapter 402 and by the host processor 504 to post WR completion events to the host.

The host processor 504 interfaces with the network processor 508 through the inter-processor queue (IPCQ) 506. The principle purpose of this queue is to allow the host processor 504 to forward data transfer requests (DTO) to the network processor 508 and for the network processor 508 to indicate the completion of these requests to the host processor 504.

The network processor 508 is responsible for managing network I/O. DTO WR are submitted to the network processor 508 by the host processor 504. These WR are converted into descriptors that control hardware transmit (TXP) and receive (RXP) processors. Completed data transfer operations are reaped from the descriptor queues by the network processor 508, processed, and if necessary DTO completion events are posted to the IPCQ for processing by the host processor 504.

Under a preferred embodiment, the bus 404 is a PCI interface. The adapter 404 has its Base Address Registers (BARs) programmed to reserve a memory address space for a virtual message queue section.

Preferred embodiments of the invention provide a message queue subsystem that manages the work request queues (host→adapter) and completion queues (adapter→host) that implement the kernel bypass interface to the adapter. Preferred message queue subsystems:
1. Avoid PCI read by the host CPU
2. Avoid locking of data structures
3. Support a very large number of user mode host clients (i.e. QP)
4. Minimize the overhead on the host and adapter to post and receive work requests (WR) and completion queue entries (CQE)

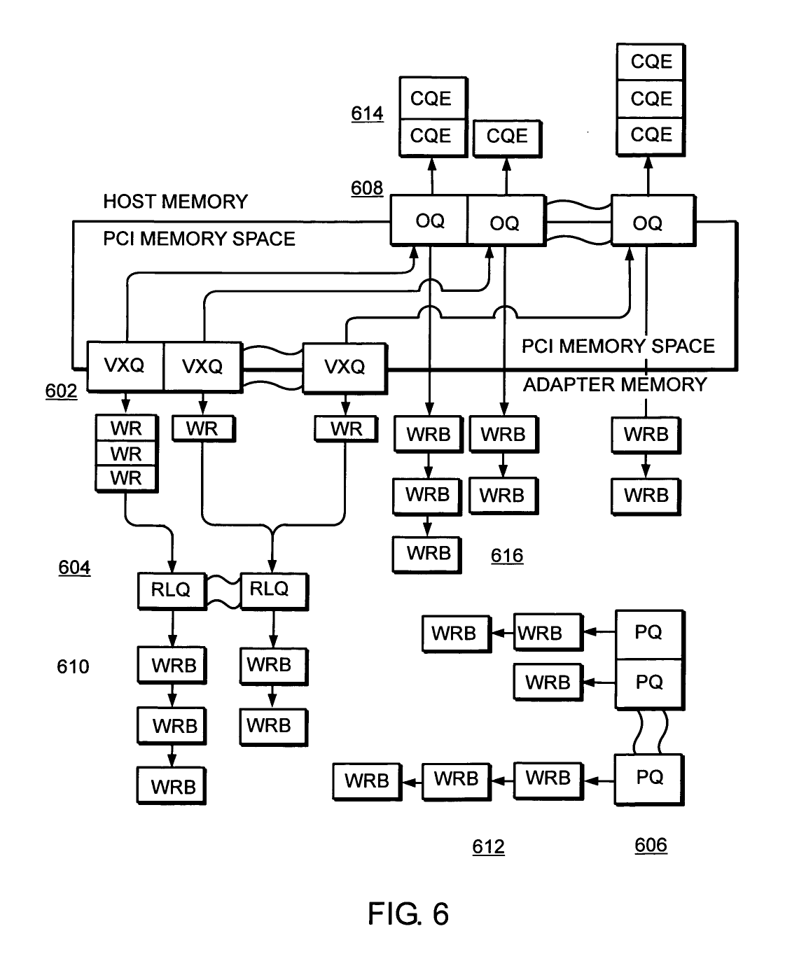

Referring to FIG. 6, the hardware subsystem consists of four queue types: Virtual Queues (VXQ) 602, Real Queues (RLQ) 604, Free Queues (FQ) 606, and Completion Queues (CQ) 608.

A VXQ 602 is used by the host to submit work requests (WR) to the adapter 402. There are a very large number of VXQ organized into groups on page boundaries in the PCI address space specified by the base address registers, e.g., BAR1. A host client submits a WR to a VXQ.

An RLQ 604 is preferably located in adapter memory and consists of a linked list 610 of WR Buffers. A WR Buffer (WRB) preferably exists in adapter SDRAM and contains a Header, a CQE, and space for the host WR. The adapter microprocessors consume WR Buffers from RLQ.

A Free Queue 606 is preferably located in adapter memory and consists of a linked list 612 of WR Buffers. When the host submits a message to a VXQ, the hardware obtains a buffer of suitable size from a FQ, and uses this message to contain the WR submitted by the host.

Finally, a Completion Queue (CQ) 608 is preferably located in adapter memory and host memory and consists of a linked list 614 of WR Buffers in adapter memory and an array 616 of CQE in host memory. The host completes a WR by writing to a CQ descriptor queue register preferably located the PCI address space, e.g., based at BAR1+x1000.

### Virtual Queues

A VXQ is called a virtual queue because messages aren't actually kept on the VXQ. The VXQ is a hardware mechanism for a user mode process to submit work requests to the adapter by writing into a page mapped into its address space. The WR is actually posted to one of a small number of RLQ on the adapter.

In addition to providing a hardware interface for submitting WR, the VXQ keeps track of the number of submitted but incomplete WR. The count of WR on the queue is incremented when the host posts a message to the VXQ and decremented when the host removes an associated CQE from a CQ. The count is maintained by the hardware and is triggered by the writing of message descriptor to a VXQ Post register and the writing of a ‘1’ to the CQ descriptor queue register. Both events are initiated by the host.

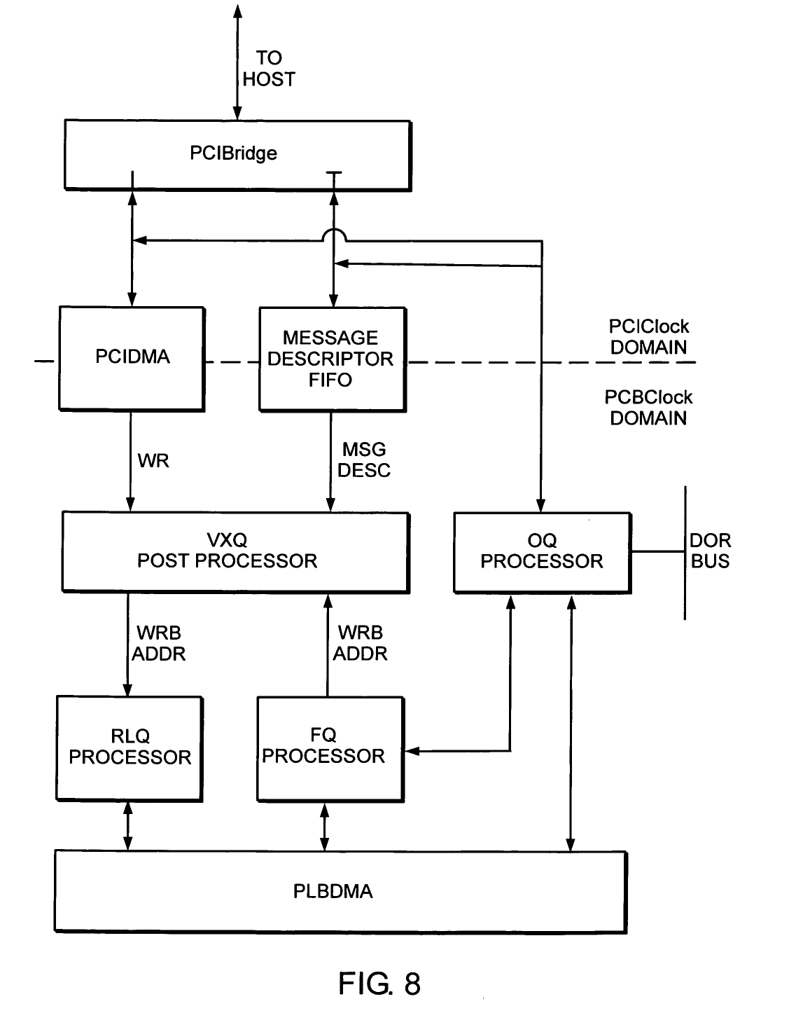

Under preferred embodiments, the PCI mapped logic consists of a VXQ Post register, and the CQ Dequeue register (more below). The host posts a message to a VXQ by writing a 64 bit message descriptor to a VXQ Post register. VXQ Post registers are organized as a memory array based at BAR1. This BAR claims a 16 MB region of PCI address space and therefore supports 16 MB/8 B=2M VXQ. Like VXQ, CQ are mapped into PCI memory. The CQ Dequeue registers are accessible through a memory window based at offset 0x1000 from BAR0. PCI writes to the VXQ Post registers are forwarded to a 4096 B FIFO through the PCI target interface. The FIFO is a 4096 B BRAM that can contain 512 8 B message descriptors. If the FIFO is full when a write is received from the host, the target generates a PCI retry. Care must be taken to ensure that the PCI retry count is configured high enough to allow at least one message descriptor to be retired from the FIFO without exhausting the retry count. If the PCI retry count is exceeded, the host PCI bridge will receive a PCI target abort that will subsequently result in a bus error being delivered to the application. When the host writes a value to the VXQ Post register, this value is forwarded to the FIFO. The consumer of the FIFO is a WR Post Processor that reads the descriptors from the FIFO, copies the WR from host memory and adds the copied WR to a linked list of WR for the target RLQ. A block diagram of this logic is shown in FIG. 8.

Each VXQ is preferably shadowed by configuration information in adapter SDRAM and by a 4096 B BRAM FIFO. The base address of the SDRAM configuration information is defined by a device control register (labeled herein as a VXD_BASE DCR register). The VXD_BASE DCR register defines the base of an array of VXD Configuration Records. Each configuration record has the following format:

| Name | Size (bits) | Description |
|---|---|---|
| VXQ_SIZE | 16 | The maximum number of WR that |
| | | can be posted to the VQ |
| VXQ_COUNT | 16 | The current number of WR posted |
| | | to the VQ |
| VXQ_CQ | 32 | A CQ identifier that specifies |
| | | which CQ gets CQE for WR completing |
| | | on this VXQ. |

The configuration records are preferably organized as an array located in SDRAM memory space. For example, the base and size of the array is defined by registers in page 0x80 of the device control register bus for the host processor 505 as follows:

| | DCR | |
|---|---|---|
| Name | Address | Description |
| VXQ_COUNT | 1 | The number of VXQ. The size |
| | | of the memory region mapped |
| | | by BAR must meet or exceed |
| | | this size. |
| VXQ_BASE | 2 | The SDRAM base address of |
| | | the VXQ attribute array |

The host submits a message to a VXQ by writing a message descriptor to a VXQ POST register. The message descriptor is written to the 4096 B FIFO. If the FIFO is full, the hardware holds off the host by generating a PCI RETRY. The VLQ POST write processor reads from the FIFO and processes the message descriptors.

A preferred message descriptor is a 64-bit value that encodes: the PCI address of the memory containing the message, the length of the message, and the queue key. A preferred message descriptor is formatted as follows:
The high order 58 bits are the PCI address of the host message buffer. The PCI address must be aligned on a 64 B boundary.
Bits 3-5 are the size class of the message. This size identifies which of eight FQ the adapter WR Buffer should be taken from. All WR Buffers in a FQ are the same size.
Bits 0-2 encode the RLQ ID. The RLQ ID specifies which of eight RLQ the WR Buffer should be posted to.

To process a write to a VXQ Post register, the hardware allocates a WRB from the specified FQ. Copies the WR in host memory to the WR Buffer, and adds the WR Buffer to the specified RLQ.

A VXQ has a number of hardware attributes that control the operation of the queue as shown in the following table, which shows the VXQ and CQ registers used by the host registers:

| Name | Size (bits) | Description | |
|---|---|---|---|
| VXQ_POST | 64 | Writing a message descriptor to this | |
| | | register through the PCI memory | |
| | | window at BAR1 causes the hardware to | |
| | | post a message to a RLQ. A message | |
| | | descriptor has the following format: | |
| | | Bits | Description |
| | | 63..6 | Specifies the physical |
| | | | address of the host |
| | | | memory containing the |
| | | | WR |
| | | 5..3 | Specifies the size-class |
| | | | for the message |
| | | | containing the WR. |
| | | 2..0 | Specifies which RLQ will |
| | | | receive the message. |

| | | |
|---|---|---|
| CQ_DQ | 32 | Writing any value to this register |
| | | causes the hardware to de-queue the next |
| | | CQE and update the VXQ Count for the |
| | | VXQ associated with the completing WR. |

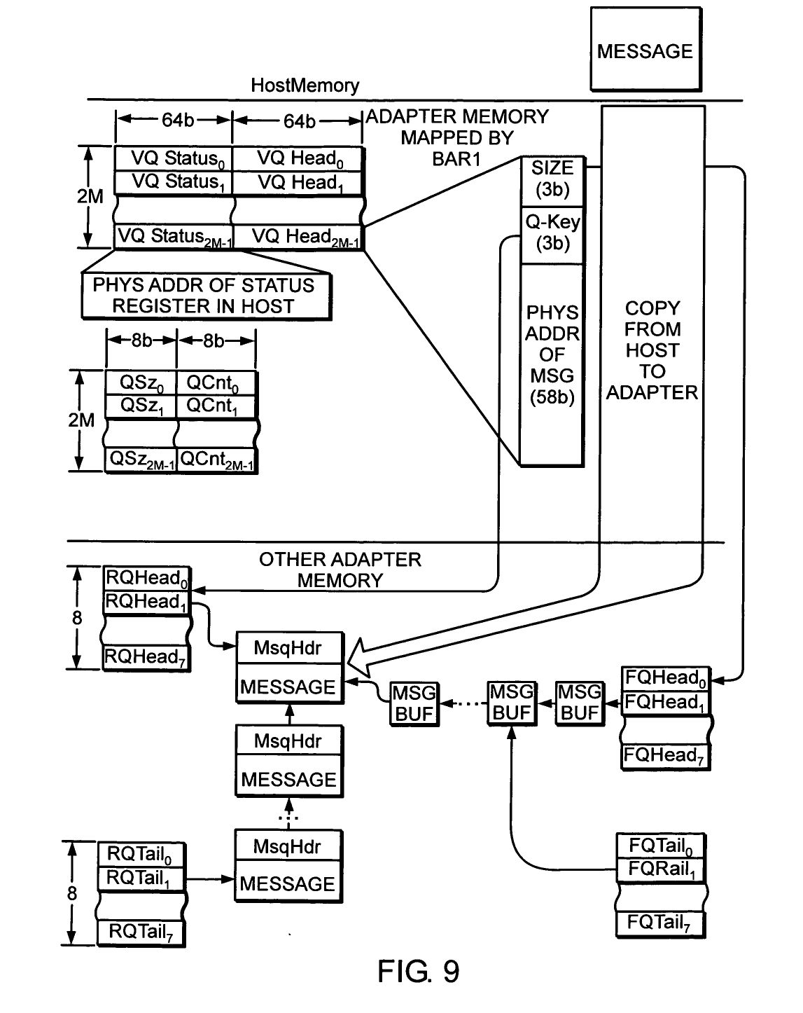

FIG. 9 illustrates a high level view of the memory organization of the message queue subsystem.

### Free Queues

Under certain embodiments, there are eight FQ in the message queue subsystem. Each queue contains a linked list 612 of WRB of the same size. The size of an WRB in a FQ is determined at initialization time by the firmware and specified in eight device control registers.

| | DCRA | |
|---|---|---|
| Name | ddress | Description |
| FQ_SIZE_0 | 1 | The size of an WRB in the 1^{st} Free |
| | | Queue |
| FQ_SIZE_1 | 2 | The size of an WRB in the 2^{nd} Free |
| | | Queue |
| FQ_SIZE_2 | 3 | The size of an WRB in the 3^{rd} Free |
| | | Queue |
| FQ_SIZE_3 | 4 | The size of an WRB in the 4^{th} Free |
| | | Queue |
| FQ_SIZE_4 | 5 | The size of an WRB in the 5^{th} Free |
| | | Queue |
| FQ_SIZE_5 | 6 | The size of an WRB in the 6^{th} Free |
| | | Queue |
| FQ_SIZE_6 | 7 | The size of an WRB in the 7^{th} Free |
| | | Queue |
| FQ_SIZE_7 | 8 | The size of an WRB in the 8^{th} Free |
| | | Queue |
| FQ_HEAD_0 | 9 | A write to this register adds the |
| | | WRB specified to the 1^{st} Free Queue. |
| | | A read from this register removes |
| | | the head of the list and returns |
| | | the address in the register. |
| FQ_HEAD_1 | 10 | A write to this register adds the |
| | | WRB specified to the 2^{nd} Free Queue. |
| | | A read from this register removes |
| | | the head of the list and returns |
| | | the address in the register. |
| FQ_HEAD_2 | 11 | A write to this register adds the |
| | | WRB specified to the 3^{rd} Free Queue. |
| | | A read from this register removes |
| | | the head of the list and returns |
| | | the address in the register. |
| FQ_HEAD_3 | 12 | A write to this register adds the |
| | | WRB specified to the 4^{th} Free Queue. |
| | | A read from this register removes |
| | | the head of the list and returns |
| | | the address in the register. |
| FQ_HEAD_4 | 13 | A write to this register adds the |
| | | WRB specified to the 5^{th} Free Queue. |
| | | A read from this register removes |
| | | the head of the list and returns |
| | | the address in the register. |
| FQ_HEAD_5 | 14 | A write to this register adds the |
| | | WRB specified to the 6^{th} Free Queue. |
| | | A read from this register removes |
| | | the head of the list and returns |
| | | the address in the register. |
| FQ_HEAD_6 | 15 | A write to this register adds the |
| | | WRB specified to the 7^{th} Free Queue. |
| | | A read from this register removes |
| | | the head of the list and returns |
| | | the address in the register. |
| FQ_HEAD_7 | 16 | A write to this register adds the |
| | | WRB specified to the 8^{th} Free Queue. |
| | | A read from this register removes |
| | | the head of the list and returns |
| | | the address in the register. |

### WR Buffer (WRB)

A WR Buffer is a data structure preferably located in adapter SDRAM. The WR Buffer contains a header, a CQE, and a WR. The format of a WR Buffer is as follows:

| Section | Attribute | Length | Description |
|---|---|---|---|
| Header | NextPtr | 4 | A pointer to the next |
| | | | element in the FQ, RLQ, |
| | | | or CQ Pending Queue |
| | | | depending on which list |
| | | | the buffer is in. |
| | VXQID | 3 | An identifier that |
| | | | specifies the VXQ to |
| | | | which the WR was |
| | | | submitted. |
| | SizeID | 1 | An identifier (0..7) |
| | | | that specifies which of |
| | | | eight FQ this WR Buffer |
| | | | comes from. |
| | CQE | 64 | A 64 byte buffer to build |
| | | | the CQE for the WR in. |
| WR | WRBuffer | FQ_SIZE[SizeID] | A buffer to contain the |
| | | | host WR. The size of this |
| | | | buffer is governed by the |
| | | | size specified in the DCR |
| | | | register associated with |
| | | | the FQ specified by the |
| | | | SizeID. |

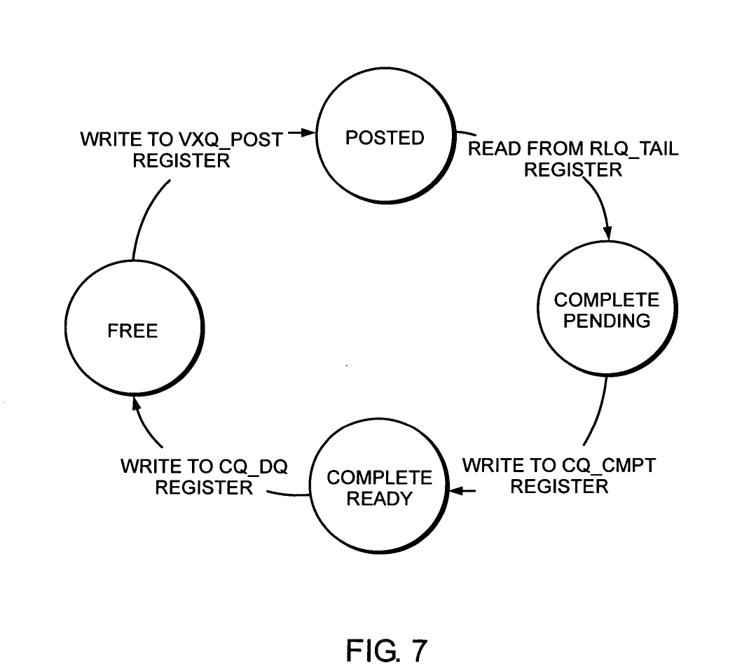

Referring to FIG. 7, under preferred embodiments, a WRB is in one of four states: free, posted, complete pending, and complete ready. In the Free state, the WRB is present on one of the eight Free Queues and is ready for use when the host posts a WR to a VXQ. In the Posted state, the WRB contains a WR submitted by the host and is present on a RLQ. A WRB moves to the Complete Pending state when the firmware reads from RLQ_TAIL register. This causes the hardware to add the message to the CQ Pending List for the CQ specified in the WRB header. In this state, the WRB is not ready for processing by the host, and the WR contained in the WRB still consumes a slot in the VXQ post count. The WRB moves to the Complete Ready state when the firmware writes the address of the WRB to the CQ_CMPT register. This causes the hardware to copy the CQE contained in the WRB to the host CQE array associated with the CQ specified in the WRB header. In this state, the WRB has been processed by the RNIC and is ready for completion processing by the host. Finally, the WRB moves back to the Free state when the host writes a ‘1’ to the CQ_DQ register for the CQ. This causes the hardware to remove the WRB from the CQ Pending List, add the WRB to the appropriate Free Queue, and update the associated VXQ Post Count.

The life cycle for the submission and completion of a WR is as follows:
Host
   Prepare a WR in a host memory buffer,
   Prepare a message descriptor specifying the host memory buffer, message buffer size class, and target RLQ,
   Write the message descriptor to the VXQ Post register,
Hardware PCI Post Logic
   Post message descriptor+VXQ ID prefix to FIFO
Hardware FIFO Logic
   Read message descriptor+VXQ ID prefix from FIFO,
   Allocate WR Buffer from Free Queue identified by size class in message descriptor,
   Copy VXQ ID prefix to WR Buffer,
   Copy WR from host memory to WR Buffer,
   Initialize CQE in WR Buffer,
   Link WR Buffer to RLQ specified in message descriptor,
SendPPC
   Dequeue WR Buffer from RLQ
   Process WR in WR Buffer and eventually completes it
   Build CQE in WR Buffer
   Write WR Buffer address to DCR CQ Post Register
Hardware
   Copy CQE to host memory into CQ Array associated with CQ
Host
   Read CQE from CQ Tail and process event
   Write ‘1’ to CQ DQ register in PCI space
Hardware
   Remove WR Buffer at head of CQ Pending List and place WR Buffer on Free List

### Real Message Queues

Under preferred embodiments, a Real Message Queue 604 is a linked list 610 of WRB. There are eight RQ in the system. The interface to the RQ is a set of eight RQ_TAIL registers located on the device control register bus. A write of a WRB address to RQ_TAIL[i] adds the specified WRB to the head of the i^{th} RQ.

A read from RQ_TAIL[i] removes the WRB at the tail of the i^{th} RQ and adds this WRB to the CQ Pending List for the CQ specified in the WRB header. The address of the WRB is returned as the result of the read. If the i^{th} RQ is empty, the value returned is 0.

### Completion Queues

A Completion Queue CQ 608 is used by the adapter to submit Completion Queue Events (CQE) 614 to the host. A CQE is a descriptor that indicates the completion status of a previously submitted WR. The CQE is a component of the WRB header and is filled in by the firmware prior to completing the WR.

The memory organization of the message queue subsystem is preferably optimized to avoid PCI reads, and allow polling in local memory (again avoiding PCI reads). The gray box in FIG. 6 that divides the VXQ and CQ boxes represents the PCI memory space. The operation of the VXQ and CQ are controlled by a combination of PCI mapped logic, and memory based attributes.

### Host VQ Usage

A host process posts a message to a message queue subsystem by writing a message descriptor to a virtual queue head. The VQ head register is 64 bits wide. On a 32 bit machine, the register must be written with two four-byte writes. Under certain embodiments, a four-byte write to the top four (most significant) bytes of the register will cause the value written to be stored into the backing SDRAM memory, but will not cause the DMA engine to start copying the message. A four-byte write to the bottom four (least significant) bytes will cause the value to be written to the backing SDRAM memory and will initiate the copying of the message to adapter memory.

Pseudo code for writing the message descriptor on a 32-bit machine is as follows:

write_vq_head(cc_u64_t* reg, cc_u64_t msg_desc)
{

cc_u32_t* reg32[2];
cc_u32_t* msg_desc32;
reg32[0] = (cc_u32_t*)(unsigned)reg64;
reg32[1] = (cc_u32_t*)((unsigned)reg64 + 4);
msg_desc32 = (cc_u32_t*)&msg_desc;
reg32[1] = msg_desc32[1];
reg32[0] = msg_desc32[0];

}

A 64 bit machine can natively write all 64 bits to the register and can be accomplished with a single write.

A VQ must be ready before it can accept a message. A host process reads from the VQ head to determine the current state of the VQ. If the state is anything other than VQ_READY, the message descriptor cannot be written.

Pseudo code for posting a message to a VQ follows:

typedef struct _vq_h_s {

cc_u64_t paddr:58;
cc_u64_t sz:3;
cc_u64_t rqid:3;

} cc_msg_desc_t;
typedef struct _vq_s {
#ifdef THREAD_SAFE

cc_mutex_t vq_mutex;

#endif

cc_u64_t* vq_h;

} cc_vq_t;
long post_vq(cc_vq_t* vq, void* m, int sz, int rqid)
{

cc_u64_t status;
cc_msg_desc_t md;

#ifdef THREAD_SAFE

mutex_acquire(vq_mutex);

#endif

/* Make sure the VQ is “ready” */
status = *vq_h.reg;
if (status) {

#ifdef THREAD_SAFE

mutex_release(vq−>vq_mutex);

#endif

return (long)status;

}
md.paddr = v2phys(msg_ptr);
md.sz = sz;
md.rqid = rqid;
write_vq_head(vq−>vq_h, md);

#ifdef THREAD_SAFE

mutex_release(vq−>vq_mutex);

#endif

return 0;

}

Since no other process has access to this queue head, there is no contention between processes. Since every VQ has a 64 bit buffer in adapter SDRAM memory, multiple processes can read status and write message descriptors to VQ heads concurrently.

### Host Message Descriptor

The host determines when the copy has completed by reading from the queue head. If the read returns the message descriptor, the copy is in progress. A zero value indicates that the copy has completed and the host memory can be safely reused. The expectation is that the host device driver will not spin waiting for the copy to complete, but rather will only perform a read when submitting a new message. If the value were zero, then all previously submitted messages have been copied. If the value is non-zero then the host must wait until the previously submitted message has been copied (or the queue drains as described below) but may then both reuse previously submitted messages and submit the new message.

### Virtual Queue Status

Virtual Queue status is determined by reading from the head register. The table below defines the return values from this register.

| Name | Value | Description |
|---|---|---|
| VQ_READY | ‘0’ | The queue is ready to receive |
| | | a message. |
| VQ_FULL | ‘1’ | The queue is full. A subsequent |
| | | post to this queue has no effect. |
| VQ_MEMFAULT | ‘2’ | The memory address specified in |
| | | the message descriptor was invalid. |
| VQ_BAD_RQ | ‘3’ | The Q-Key specified in the message |
| | | descriptor was invalid. |
| VQ_BUSY | ? | The hardware does not change the |
| | | value of the head register until |
| | | the message copy is complete. If a |
| | | read from the head register returns |
| | | the non-zero bits in the top |
| | | 58 bits, the copy is still in |
| | | progress. |

### Queue Flow Control

A queue has a fixed size that is specified in the size register by the firmware when the VQ is configured. The adapter increments the element count whenever the host writes a message descriptor to the queue head. If the element count equals the queue size the element is not added to the queue and a read from the queue head will return the value VQ_FULL. The size register is read-only to the host.

Adapter firmware is responsible for decrementing the VQ element count. The expectation is that if the VQ is used to implement an RNIC QP, then decrementing the element count is done when the WQE represented by the VQ message is completed.

Prior to posting a message, the host should check to see if the VQ is full or busy by reading from the VQ head. If the return value is non-zero, then the VQ is full, or the VQ is busy (copy in progress, or free queue exhausted).

### Virtual Adapter Message Header Status

An adapter side message includes a 16 byte header. This header is not visible to the host; i.e. the host does not reserve space at the front of a message for this header. The adapter message, however, includes this header, and therefore, message buffers maintained by firmware must be 16 B longer than the message length advertised to the host. The format of this header is as follows:

| Field | Length | Description |
|---|---|---|
| Q-ID | 4 | The MuxMQ number (register offset |
| | | >> 3) to which the message was |
| | | submitted |
| Reserved | 3 | |
| Length | 1 | The message size class (from the |
| | | host message descriptor). This value |
| | | is set by the hardware when a message |
| | | is posted. It is used by the firmware |
| | | when returning a message to a free |
| | | queue. |
| Post Ptr | 4 | A pointer to the next message when on |
| | | the post queue. This message is set by |
| | | the hardware when posting a message. |
| Free Ptr | 4 | A pointer to the next free message when |
| | | on the free queue. This value is read |
| | | by the hardware when removing a message |
| | | buffer from a free queue. |

### Real Queue Logic

Under preferred embodiments, the hardware and firmware cooperates to manage the real queue. In particular, the hardware posts messages to a real queue, and the firmware removes them. Conversely, the hardware removes messages from the free queue and the firmware puts them back.

The hardware and firmware logic for managing the post and free queues follows:

/* Usage assumptions:

| | |
|---|---|
| * 1. | There is only one hardware tasks. |
| * 2. | There is only one software task. |
| * 3. | hardware_init runs before the first software or hardware |
| * | interaction with the queues. |

*/
/* Definition of a message header */
typedef struct _msg_hdr_s {

| | |
|---|---|
| unsigned long | muxmq_id; |

| | |
|---|---|
| char | reserved[3]; |

| | |
|---|---|
| struct _msg_hdr_s* | post_ptr; |
| struct _msg_hdr_s* | free_ptr; |

} cc_msg_hdr_t;
/* Definition of a VQ head register. Only used below in
* hardware_init */
typedef struct _head_reg_s {

cc_u64_t paddr:58;
cc_u64_t sz:3;
cc_u64_t rqid:3;

} cc_mux_hr_t;
cc_mux_hr_t mux_hr[2M];
/* Definition of a size-count register */
typedef struct _sz_cnt_s {

cc_u16_t cnt;
cc_u16_t sz;

```
} cc_mux_sz_cnt_t;
/* Real queue size and count registers. These registers are located
  * at offset 16M in the message memory area.
  */
cc_sz_cnt_t mux_mq_sc[2M];
/* head and tail registers for the real queues. These registers are
  * located at offset 24M in the message memory area.
  */
cc_msg_hdr_t* mux_rq_h[8];
cc_msg_hdr_t* mux_rq_t[8];
cc_msg_hdr_t* mux_fq_h[8];
cc_msg_hdr_t* mux_fq_t[8];
void hardware_put_msg(int mq_id, int rq_id, cc_msg_hdr_t* m)
{
```

if (mux_rq_h[rq_id] == NULL)
mux_rq_t[rq_id] = m;
m−>muxmq_id = mq_id;
m−>post_ptr = mux_rq_h[rq_id];
mux_rq_h[rq_id] = m−>post_ptr;

}
cc_msg_hdr_t* firmware_get_msg(int rq_id)
{

cc_msg_hdr_t* m;
m = mux_rq_t[rq_id];
if (m)
mux_rq_t[rq_id] = mux_rq_t[rq_id]−>post_ptr;
return m;

}
cc_msg_hdr_t* hardware_get_free(int sz_id)
{

cc_msg_hdr_t* m = mux_fq_t[sz_id];
if (m)
mux_fq_t[sz_id] = m−>free_ptr;
return m;

}
void firmware_put_free(int sz_id, cc_msg_hdr_t* m)
{

if (mux_fq_t[sz_id] == 0)
mux_fq_t[sz_id] = m;
m−>free_ptr = mux_fq_h[sz_id];
mux_fq_h[sz_id] = m;

}
void hardware_init( )
{

for (int i=0; i < 8; i++) {
mux_mq_h[i] = 0;
mux_mq_t[i] = 0;
mux_fq_h[i] = 0;
mux_fq_t[i] = 0;
}
for (i=0; i < 2M; i++) {
mux_mq_sc[i].cnt = 0;
mux_mq_sc[i].sz = 0;
mux_mq_hr[i].paddr = 0;
mux_mg_hr[i].sz = 0;
mux_mq_hr[i].rqid =0;
}

}

### Firmware Interface

Under certain embodiments, the firmware interface to the virtual queues consists of an array of size-count registers. A VQ must be “configured” before it can be used by the hardware. A VQ is considered configured when it has a non-zero size in the size-count register. The firmware initializes these messages in response to a request from the host. Such a request is submitted using a software verbs queue.

The firmware is responsible for managing configured and available VQ. The expectation is that these queues will be grouped into page boundaries. The firmware must know which process is requesting queue creation and allocate all requests for a single process from the same group. It should never be the case that two processes receive queues from the same group.

The firmware interface to the real queues consists of:
1. The free queue tail pointer array,
2. The free queue head pointer array,
3. The post queue tail pointer array, and
4. The post queue head pointer array.

Before a message can be copied to the adapter, there must be messages available for the specified size class. These messages are posted by the firmware during initialization. The expectation is that the firmware will populate these queues with messages as VQ area allocated by the host. When a sufficiently large number of messages of each size class have been added, the firmware may decide to under provision and let VQ share these adapter side messages.

### Free Queue Exhaustion

It is possible for the host to submit a message descriptor to a VQ head for which there is no corresponding message buffer in the free queue. In this case, the hardware will set a bit in a status register. This 32-bit status register is preferably located on the device control register bus of the adapter's host processor 504. Bits 0 through 7 identify a free queue empty condition. These bits are set by the hardware when the hardware attempts to allocate a message, but finds an empty free queue. The host processor 504 should reset these bits after adding additional messages, but may choose to ignore the condition. Ignoring the condition simply causes the host to continue to wait for the busy condition in the VQ to clear.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A message queue subsystem for an RDMA-capable network interface, comprising:
a memory mapped virtual queue interface having a large plurality of virtual message queues with each virtual queue mapped to a specified range of memory address space;
logic to detect work requests on a host interface bus to at least one of specified address ranges corresponding to one of the virtual queues;
logic to place the work requests into a real queue that is memory based and shared among at least some of the plurality of virtual queues, and wherein real queue entries include indications of the virtual queue to which the work request was addressed.

2. The message queue subsystem of claim 1 wherein the virtual queues include send queues and receive queues and in which data for a queue entry is resident in memory on the network interface.

3. The message queue subsystem of claim 1 wherein the message queue subsystem includes a completion queue interface, wherein each virtual queue has a corresponding completion queue, and wherein each completion queue has its queue entries resident in host memory thereby avoiding host read requests to the network interface memory to determine completion status.

4. The message queue subsystem of claim 1 wherein the real queue is a linked list of queue entries and wherein the queue subsystem includes hardware logic to manage the linked list.

5. The message queue subsystem of claim 1 wherein virtual queue are grouped into pages of memory address space allowing the secure association of virtual queues with a single host process.

6. The message queue subsystem of claim 1 wherein the virtual queues are organized as a memory array based off an address programmed into a base address register of the network interface.

7. The message queue subsystem of claim 1 wherein a multiplicity of work request sizes are supported within a single real queue.

8. A method of message queuing work requests for an RDMA-capable network interface, comprising:
mapping a large plurality of virtual message queues into a memory address space such that each virtual queue of the plurality is mapped to a specified range of memory address space;
detecting work requests on a host interface bus if they are to at least one of specified address ranges corresponding to one of the virtual queues;
placing the work requests into a real queue that is memory based and shared among at least some of the plurality of virtual queues, and wherein real queue entries include indications of the virtual queue to which the work request was addressed.

9. The method of claim 8 wherein the virtual queues include send queues and receive queues and in which data for a queue entry is resident in memory on the network interface.

10. The method of claim 8 wherein the message queue subsystem includes a completion queue interface, wherein each virtual queue has a corresponding completion queue, and wherein each completion queue has its queue entries resident in host memory thereby avoiding host read requests to the network interface memory to determine completion status.

11. The method of claim 8 wherein the real queue is a linked list of queue entries and wherein the queue subsystem includes hardware logic to manage the linked list.

12. The method of claim 8 wherein virtual queue are grouped into pages of memory address space allowing the secure association of virtual queues with a single host process.

13. The method of claim 8 wherein the virtual queues are organized as a memory array based off an address programmed into a base address register of the network interface.

14. The method of claim 8 wherein a multiplicity of work request sizes are supported within a single real queue.
